(19) United States
(12) Patent Application Publication
(10) Pub. No.: US 2026/0288594 A1
(43) Pub. Date: Sep. 24, 2026

(54) MANAGING A DATA PROCESSING SYSTEM USING PERSISTENTLY STORED EVENT DATA

(71) Applicant: Dell Products L.P., Round Rock, TX (US)

(72) Inventors: IBRAHIM SAYYED, Georgetown, TX (US); ADOLFO SANDOR MONTERO, Pflugerville, TX (US); GIRISH PRAKASH, Georgetown, TX (US)

(21) Appl. No.: 19/085,796

(22) Filed: Mar. 20, 2025

(51) Int. Cl. G06F 11/14; G06F 11/20

(52) U.S. Cl. CPC G06F 11/1446; G06F 11/2015

(57) ABSTRACT

Methods and systems for managing operation of a data processing system are disclosed. To manage the data processing system, a management controller of the data processing system may identify an occurrence of a predefined event relevant to operation of hardware resources of the data processing system. The predefined event may be distinct from a startup event identified based on actions performed as part of a resumption process by a startup management entity. Event data relevant to the predefined event may be provided to the startup management entity by the management controller via a side band channel. The startup management entity may store the event data in a persistent storage resource so that the event data is available to a software service after completion of the resumption. The software service may use the event data to perform an action to manage operation of the data processing system.

### FIELD

Embodiments disclosed herein relate generally to managing operation of a data processing system. More particularly, embodiments disclosed herein relate to managing operation of the data processing system by using event data that may be obtained by a management controller and provided to a startup management entity for persistent storage.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1C show diagrams illustrating a system in accordance with an embodiment.

FIG. 2 shows an interaction diagram in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing system may provide computer-implemented services to any type and number of other devices and/or users of the data processing system. The computer-implemented services may include any quantity and type of such services.

To provide the computer-implemented services, the data processing system may perform a resumption process (e.g., a booting process, a wake-up process, etc.) to initialize and/or resume operation of hardware resources hosted by the data processing system. While doing so, a processor (e.g., a central programming unit (CPU)) of the hardware resources may be managed by a startup management entity (e.g., basic input/output system (BIOS) firmware).

The startup management entity may obtain information regarding startup events that occur during the resumption. The information may be used by a software service (e.g., an operating system agent to manage operation of the data processing system after completion of the resumption and while the processor is managed by an operating system.

However, an event may occur during and/or prior to the resumption relevant to operation of the hardware resources that may not be identified by the startup management entity. For example, the event may include a change in an operational state of a hardware component (e.g., memory, disk, etc.), a change in operating conditions of a battery, a thermal event, a physical impact event (e.g., drop event), an electrical disturbance (e.g., power surge), and/or any other events that may impact desired operation of the data processing system.

To manage operation of the data processing system in an event of compromise and/or reduced functionality of at least a portion of the hardware resources, the data processing system may host a management controller that may operate independently from the hardware resources and may be distinct from and adapted to manage the hardware resources. For example, the management controller may operate during the booting process and/or regardless of an outcome of the booting process performed by booting components (e.g., the boot storage device and/or the processor) of the hardware resources.

The management controller may identify a predefined event that may not be based on actions performed as part of the resumption and/or consequences of the actions being performed as part of the resumption by the startup management entity. Accordingly, the management controller may obtain event data relevant to the predefined event and provide the event data to the startup management entity via a side band channel during the startup. Because software resources may have limited access to data obtained prior to completion of the startup, an ability of software resources to manage operation of the data processing system using the data relevant to the predefined event may be reduced.

To improve a likelihood that the data processing system may be managed using the event data, the startup management entity may store the event data in a persistent storage resource that may be available to software resources (e.g., the software service) after completion of the resumption. To do so, the event data may be added to a data structure that may include, for example, the information regarding the startup events, and second information regarding occurrences of the predefined event.

By doing so, the software service may retrieve the data structure from the persistent storage resource and process the data structure to identify the occurrence of the predefined event. For example, the software service may evaluate the event data relevant to the predefined event (e.g., by comparing the event data to criteria) to identify at least one management action to perform based on the evaluation. The management action may include, for example, communicating with a remote management entity that may perform at least one action based on the occurrence of the predefined event. For example, the management entity may proactively provide a replacement for a hardware component, virtual assistance to address the predefined event, and/or any other services to improve a likelihood that the data processing system may be placed in a desired operating state.

Thus, embodiments disclosed herein may provide an improved method for managing operation of a data processing system by persistently storing event data during a resumption process of the data processing system so that the event data may be available to a software service after completion of the resumption process. The event data may be relevant to a predefined event that may impact operation of hardware resources of the data processing system. By doing so, at least one action may be performed based on the occurrence of the predefined event to place the data processing system in a desired operating state.

In an embodiment, a method for managing operation of a data processing system is provided. The method may include: (i) identifying, by a management controller of the data processing system, an occurrence of a predefined event during a resumption of the data processing system, the predefined event being relevant to operation of hardware resources of the data processing system; (ii) based on the identifying: (a) providing, by the management controller via a side band channel, event data regarding the predefined event to a processor of the hardware resources, the processor being managed by a startup management entity during the resumption; (b) storing, by the startup management entity, the event data in a persistent storage resource so that the event data is available to a software service after completion of the resumption; (c) obtaining, by the software service, the event data from the persistent storage resource while the hardware resources are managed by an operating system; and (d) performing, by the software service, at least one action using to the event data to facilitate provisioning of computer-implemented services.

The persistent storage resource may store a data structure that may include: (i) first information regarding occurrences of startup events identified by the startup management entity during performance of the resumption; and (ii) second information regarding the occurrence of the predefined event identified by the management controller, the occurrence of the predefined event occurring during the performance of the resumption, and the occurrence of the predefined event not being based on actions performed as part of the resumption and/or consequences of the actions being performed as part of the resumption.

The predefined event may include at least one event from a list of events consisting of: (i) a change in an operational state of a hardware component of the hardware resources; (ii) a change in an operating condition of a battery of the hardware resources; (iii) a thermal event; (iv) a physical impact event; and (v) an electrical disturbance.

Storing the event data may include: (i) adding the event data to the data structure hosted by the persistent storage resource.

The software service may be adapted to automatically process the data structure to identify at least the occurrence of the predefined event after the completion of the resumption.

The software service may perform the automatic processing after the completion of the resumption when a notification is received from the management controller.

Obtaining the event data may include: (i) retrieving, by the software service, the event data from the persistent storage resource based on the notification.

Performing the at least one action may include: (i) evaluating, by the software service, the event data based on an event policy to obtain an evaluation result; and (ii) performing at least one management action based on the evaluation result.

Performing the at least one management action may include: (i) providing, by the software service, the event data and/or the evaluation result to a remote entity tasked with managing operation of the data processing system.

The management controller may operate independently from and may be distinct from the hardware resources.

The management controller may be on a separate power domain from the hardware resources so that the management controller may be operable while the hardware resources are inoperable.

In an embodiment, a non-transitory media is provided. The non-transitory media may include instructions that when executed by a processor cause the computer-implemented method to be performed.

In an embodiment, a system is provided. The system may include the non-transitory media and a processor, and may perform the computer-implemented method when the computer instructions are executed by the processor.

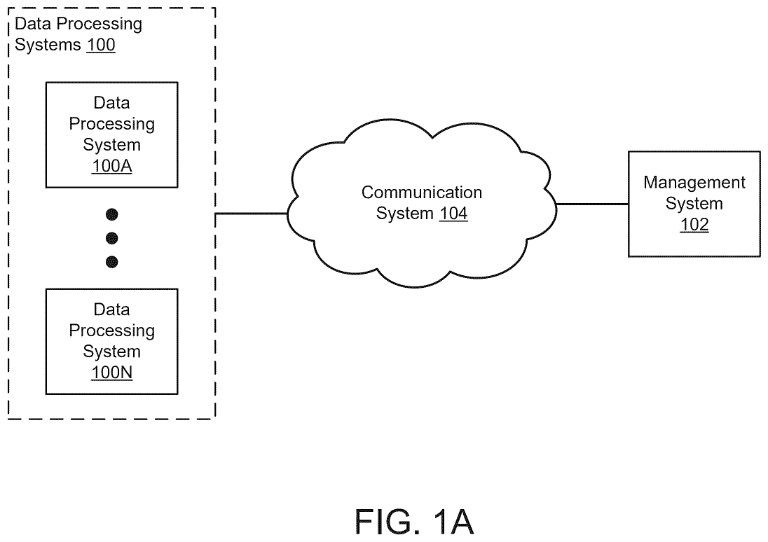

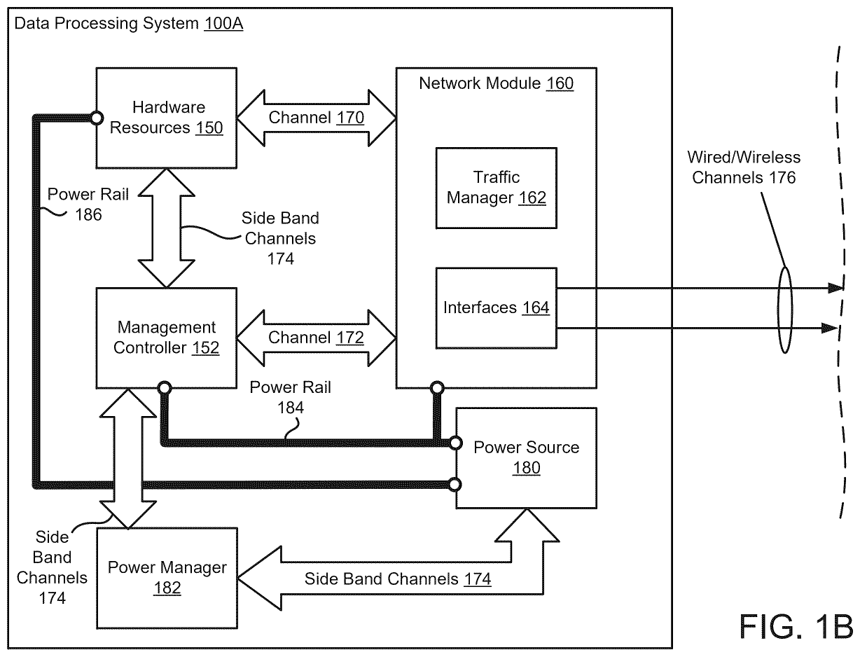

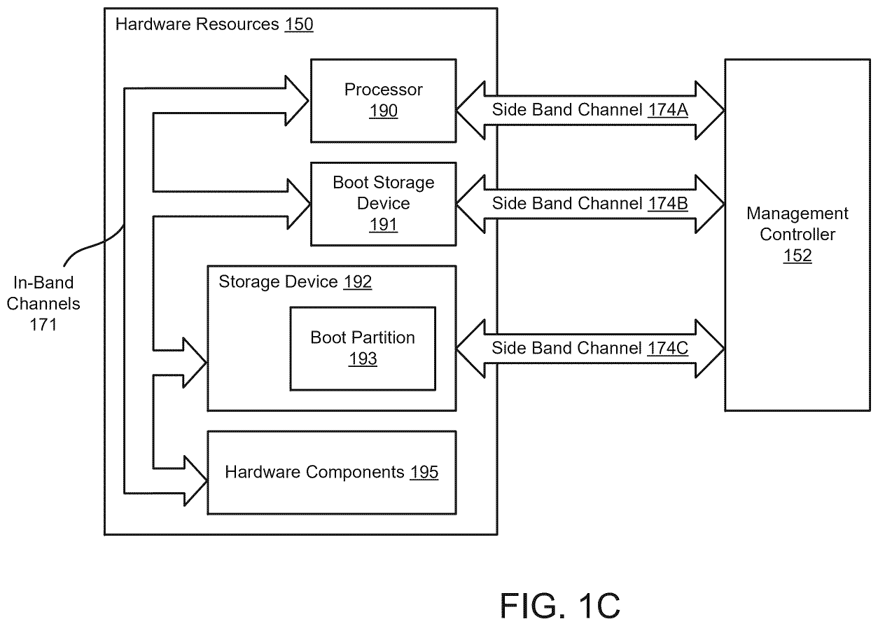

Turning to FIG. 1A, a block diagram illustrating a system in accordance with an embodiment is shown. The system shown in FIG. 1A may provide for management of data processing systems that may provide, at least in part, computer-implemented services (e.g., to user of the system and/or devices operably connected to the system).

The system may include any number of data processing systems 100 (e.g., computing devices) that may each include any number of hardware components (e.g., processors, memory modules, storage devices, communication devices, etc.). The hardware components may support execution of any number and types of applications (e.g., software components). Changes in available functionalities of the hardware and/or software components may provide for various types of different computer-implemented services to be provided over time. Refer to FIG. 1B for additional details regarding data processing systems 100.

The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, data processing systems 100, management system 102, and/or any other type of devices (not shown in FIG. 1A). Other types of computer-implemented services may be provided by the system shown in FIG. 1A without departing from embodiments disclosed herein.

The computer-implemented services may be provided at least in part, by hardware resources of data processing systems 100. To provide the computer-implemented services, a data processing system may perform a resumption process to initialize and/or resume operation of the hardware resources. The resumption process may include, for example, a startup process (e.g., powering on the data processing system from a depowered state), a wake-up process (e.g., a transition from a low-powered operating state to a high-powered operating state), and/or any other processes to resume operation of the data processing system. For example, to perform the resumption process, a processor (e.g., a central programming unit (CPU)) of the hardware resources may utilize boot data (e.g., basic input/output system (BIOS) firmware, system configuration files, etc.) that may be stored on a boot storage device. Accordingly, the processor may be managed by a startup management entity (e.g., BIOS, unified extensible firmware interface (UEFI), etc.) during the startup.

While the resumption process is performed, the startup management entity may identify occurrences of startup events. For example, the startup management entity may perform a power-on self-test and/or diagnostics to identify operating states of any number and/or type of hardware components of the hardware resources, system configurations, and/or any other information. The startup management entity may obtain information (e.g., a BIOS log) regarding the startup events that may be used by a software service (e.g., an operating system agent adapted to manage operation of the data processing system after completion of the startup and while the processor is managed by an operating system) to provide at least a portion of the computer-implemented services.

However, additional events may occur prior to and/or during the resumption that may not be based on actions performed by the startup management entity. The additional events may impact operation of the hardware resources and/or occur while at least a portion of the hardware resources are inoperable (e.g., powered off, compromised, etc.). Consequently, a quality of the computer-implemented services provided by the software service may be limited if the software service is unable to access event data relevant to the additional events.

To manage operation of the data processing system in an event of compromise and/or reduced functionality of at least a portion of the hardware resources, the data processing system may host a management controller that may operate independently from the hardware resources and may be distinct from and adapted to manage the hardware resources. As such, the management controller may operate during the startup and/or regardless of an outcome of the startup performed by startup components (e.g., the boot storage device and/or the processor) of the hardware resources.

In general, embodiments disclosed herein relate to systems, devices, and methods for managing operation of a data processing system. To manage the operation of a data processing system, the management controller may obtain event data regarding a predefined event relevant to operation of hardware resources of the data processing system. The event data may be persistently stored so that the event data may be accessible by a software service adapted to manage operation of the data processing system using the event data.

To obtain the event data, the management controller may identify the occurrence of the predefined event (e.g., an additional event not based on tests performed by the startup management entity during the startup), for example, by obtaining information (e.g., monitoring, recording telemetry data, etc.) from hardware components using respective side band channels. The predefined event may include, for example, a change in an operational state of a hardware component (e.g., memory, disk, etc.), a change in operating conditions of a battery, a thermal event, a physical impact event (e.g., drop event), an electrical disturbance (e.g., power surge), and/or any other events that may impact desired operation of the data processing system. For example, consider a scenario in which the hardware components generate telemetry data (e.g., via sensors) while the data processing system is in a low-powered operating state (e.g., sleep state). Because the hardware components may have limited storage capacity to store the telemetry data, the hardware components may transmit the telemetry data to the management controller for further management.

Once obtained, the management controller may provide the event data to the startup management entity during the resumption via a side band channel between the management controller and the processor. The startup management entity may store the event data by adding the event data to a data structure (e.g., the BIOS log) hosted by a persistent storage resource (e.g., non-volatile memory). Accordingly, the data structure may include first information regarding occurrences of the startup events identified by the startup management entity during the resumption and second information (e.g., the event data) regarding the occurrence of the predefined event.

Furthermore, the startup management entity may store the data structure in a manner that may be more trusted compared to a second manner that may be used by the management controller to store information for subsequent use by the software service. For example, the startup management entity may sign the data structure using a trusted key (e.g., a private key of a public-private key pair), demonstrate authority to store the data structure in the persistent storage resource with a trusted platform module during the resumption, and/or via any other processes.

By doing so, after completion of the resumption, the software service may retrieve the data structure from the persistent storage resource and process the data structure to identify, at least, the occurrence of the predefined event. The software service may be adapted to automatically process the data structure, for example, when a notification is received from the management controller after the completion of the resumption (e.g., when an operating system assumes management of the processor and/or the software service is identified to be operating cooperatively with the operating system).

For example, to process the data structure, the software service may evaluate the event data relevant to the predefined event (e.g., by comparing the event data to criteria) to identify at least one management action to perform based on the evaluation. The management action may include, for example, communicating with a remote management entity (e.g., management system 102) that may perform at least one action based on the occurrence of the predefined event. For example, the management entity may proactively provide a replacement for a hardware component, virtual assistance to address the predefined event, and/or any other services to improve a likelihood that the data processing system may be placed in a desired operating state.

To provide the above noted functionality, the system may include data processing systems 100, and management system 102. Each of these components is discussed below.

Data processing systems 100 may include any number of data processing systems (e.g., 100A-100N) that may individually and/or cooperatively provide at least a portion of the computer-implemented services. Any of data processing systems 100 may include in-band components (e.g., hardware resources), out-of-band components (e.g., management controller, network modules, etc.), and functionality that may allow the out-of-band components to communicate with management system 102 via an out-of-band communication channel.

While providing the at least a portion of the computer-implemented services, a data processing system (e.g., 100A) of data processing systems 100 may communicate with and/or obtain information from management system 102. For example, data processing system 100A may provide event data relevant to operation of hardware resources of data processing system 100A and/or results of an evaluation of the event data, obtain instructions relevant to updating operation of the hardware resources, receive physical components and/or support based on the event data, and/or perform any other actions. Data processing system 100A may subsequently perform actions based on the information obtained from management system 102 to update operation of data processing system 100A.

Management system 102 may, as discussed above, provide remote management services. Management system 102 may include, for example, a second data processing system operated an owner of data processing systems 100. To provide the remote management services, management system 102 may interact with data processing systems 100 to obtain and/or provide information (e.g., data) relevant to operation of data processing systems 100. For example, management system 102 may generate and provide an event policy (e.g., that may define actions to perform to identify and/or based on a set of predefined events) to each data processing system of data processing systems 100, obtain event data and/or results of evaluation of the event data from a data processing system, perform a management action (e.g., dispatching a replacement for a hardware component inferred to be operating in a potentially undesired manner, providing virtual support to address an identified issue, etc.), and/or provide any other services to manage operation of data processing systems 100.

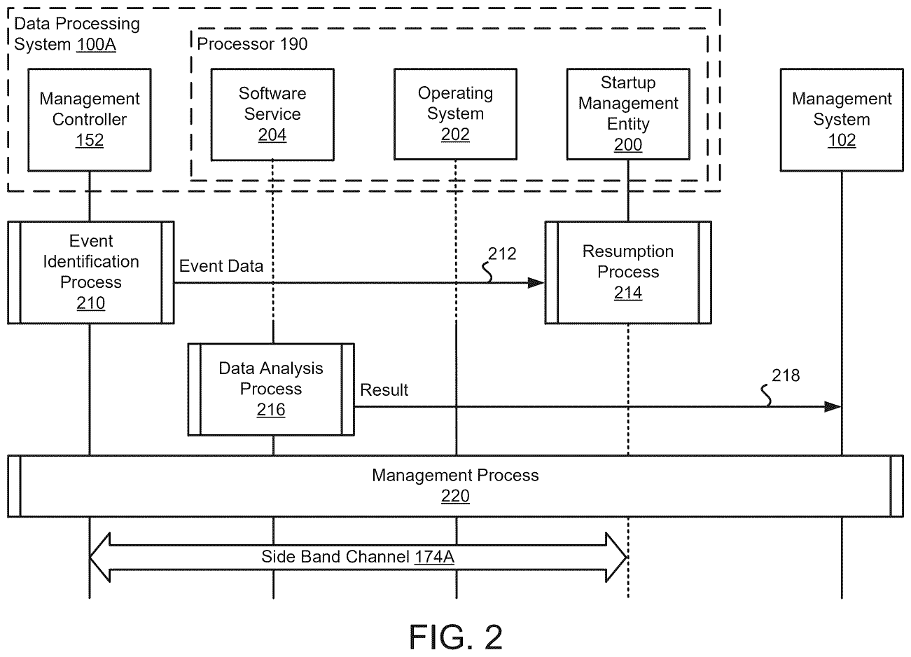

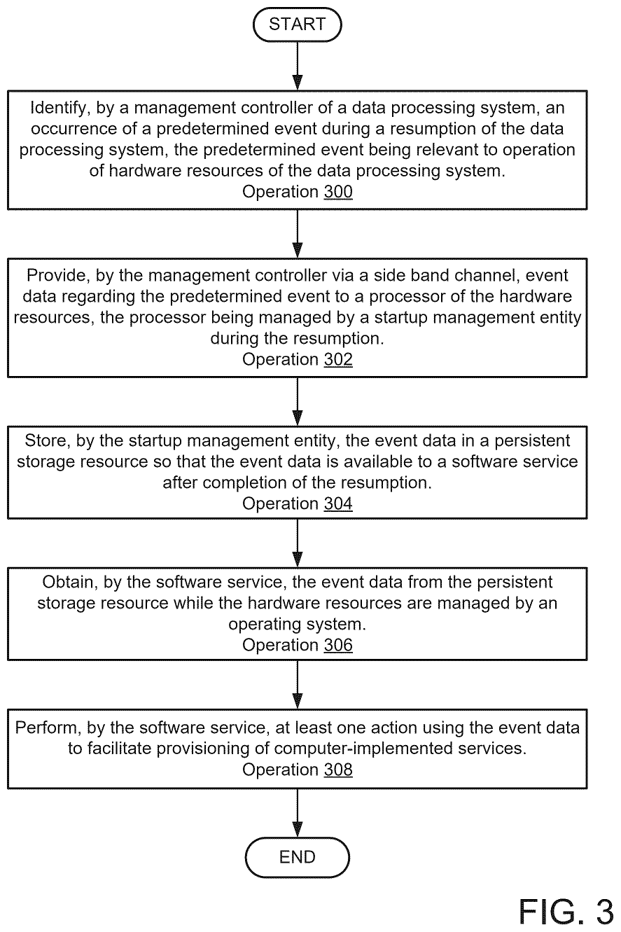

While providing their functionality, any of data processing systems 100, and management system 102 may provide all or a portion of the methods shown in FIGS. 2-3.

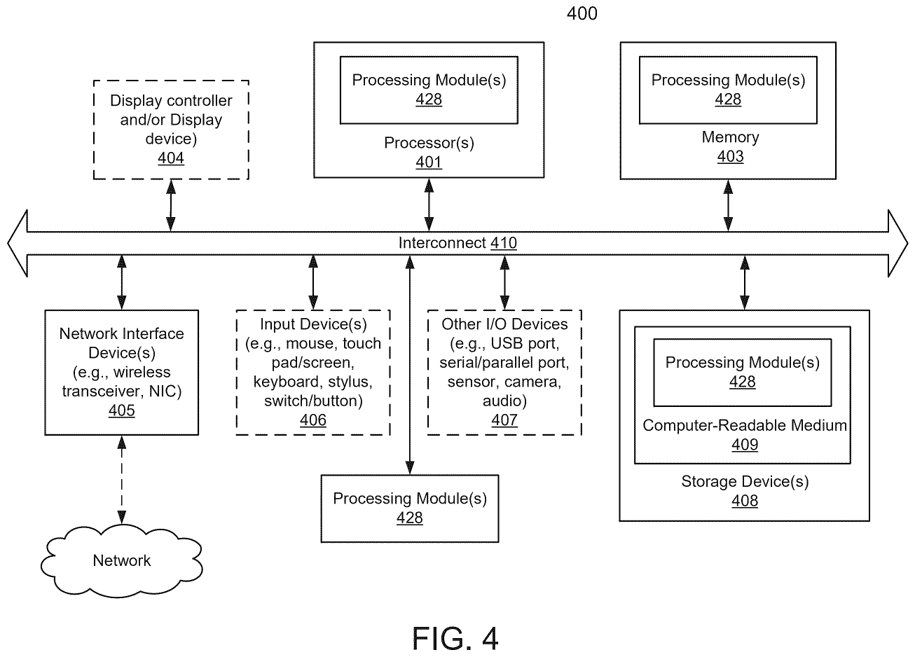

Communication system 104 may allow any of data processing systems 100, and management system 102 to communicate with one another (and/or with other devices not illustrated in FIG. 1A). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to management system 102 via the Internet. Data processing systems 100, management system 102, and/or communication system 104 may be adapted to perform one or more protocols for communicating via communication system 104.

Any of (and/or components thereof) data processing systems 100, and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1A, a system in accordance with an embodiment may manage operation of a data processing system by persistently storing event data relevant to a predefined event identified during and/or prior to a startup of the data processing system. The event data may subsequently be used by a software service and/or a remote management entity to perform a management action to facilitate provisioning of computer-implemented services by the data processing system.

While illustrated in FIG. 1A with a limited number of specific components, a system may include additional, fewer, and/or different components without departing from embodiments disclosed herein.

Turning to FIG. 1B, a diagram illustrating a data processing system in accordance with an embodiment is shown. Data processing system 100A shown in FIG. 1B may be similar to any of the data processing systems shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components.

The storage may include any number and/or types of storage devices (e.g., hard drives, solid state drives, etc.). A storage device of the storage devices may include, for example, memory (e.g., non-volatile memory), a controller that may manage data operations (e.g., storage, retrieval, organization, etc.), and/or other physical components. The storage device may support storage protocols (e.g., non-volatile memory express) that may facilitate use of storage resources of the storage device.

For example, the storage may include a first storage device adapted to host an image of a startup management entity (e.g., BIOS, UEFI, etc.), system configurations, and/or any other information. Additionally, the storage may include a second storage device that may include, but not be limited to, storage for information necessary to boot the data processing system, load an operating system for the data processing system, and/or perform any other processes.

The processor may host various management entities such as operating systems, drivers, network stacks, and/or other software entities that provide various management functionalities. For example, the operating system and drivers may provide abstracted access to various hardware resources.

To facilitate communication, hardware resources 150 may host a network stack that may facilitate packaging, transmission, routing, and/or other functions with respect to exchanging data with other devices. For example, the network stack may support transmission control protocol/internet protocol communication (TCP/IP) (e.g., the Internet protocol suite) thereby allowing hardware resources 150 to communicate with other devices via packet switched networks and/or other types of communication networks.

The processor may also host various applications that provide the computer-implemented services. The applications may utilize various services provided by the management entities and use (at least indirectly) the network stack to communication with other entities.

However, use of the network stack and the services provided by the management entities may place the applications at risk of indirect compromise. For example, if any of these entities trusted by the applications are compromised, these entities may subsequently compromise the operation of the applications. Additionally, if various drivers and/or the communication stack are compromised, communications to/from other devices may be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100A) to another device via any number of intermediate networks (e.g., via wired/wireless channels 176 that are part of the networks).

To reduce the likelihood of the applications and/or other in-band entities from being indirectly compromised, data processing system 140 may include management controller 152 and network module 160. Each of these components of data processing system 140 is discussed below.

Management controller 152 may be implemented, for example, using a system on a chip or other type of independently operating computing device (e.g., independent from the in-band components, such as hardware resources 150, of a host data processing system 100A). Management controller 152 may provide various management functionalities for data processing system 100A. For example, management controller 152 may monitor various ongoing processes performed by the in-band components, may manage power distribution, thermal management, and/or other functions of data processing system 100A.

To provide the management functionalities, management controller 152 may utilize data that may, at least temporarily be stored on storage resources hosted by management controller 152. For example, management controller 152 may download an image of a new management entity (e.g., firmware, application, etc.) in response to a management request, store the image, and install the new management entity using at least the image on hardware resources 150. However, a capacity of the storage resources hosted by management controller 152 may be limited. To improve a likelihood that the data (e.g., event data relevant to a predefined event impacting operation of hardware resources 150) may be usable to manage data processing system 100A, management controller 152 may communicate the data to a processor and/or storage resources for storage.

To do so, management controller 152 may be operably connected to various components via side band channels 174 (in FIG. 1B, a limited number of side band channels are included for illustrative purposes, it will be appreciated that management controller 152 may communication with other components via any number of side band channels). The side band channels may be implemented using separate physical channels, and/or with a logical channel overlay over existing physical channels (e.g., logical division of in-band channels). The side band channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, management controller 152 may identify an occurrence of a predefined event occurring during performance of a startup of data processing system 100A. Based on the identification, obtaining and/or providing event data relevant to the occurrence of the predefined event to a startup management entity during the startup, and/or perform any other management functionalities using side band channels 174.

Management controller 152 may be operably connected to communication components of data processing system 100A via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted component may not result in indirect compromise of any management controller 152, and entities hosted by management controller 152.

To facilitate communication with other devices, data processing system 100A may include network module 160. Network module 160 may provide communication services for in-band components and out-of-band components (e.g., management controller 152) of data processing system. To do so, network module 160 may include traffic manager 162 and interfaces 164.

Traffic manager 162 may include functionality to (i) discriminate traffic directed to various network endpoints advertised by data processing system 100A, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100A may appear to be two independent network entities, that may independently addressable, and otherwise unrelated to one another.

To facilitate management of data processing system 100A over time, hardware resources 150, management controller 152 and/or network module 160 may be positioned in separately controllable power domains. By being positioned in these separately controllable power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100A may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 that is supplied to the power rails. Management controller 152 may cooperate with power manager 182 to manage supply of power to these power domains.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

When providing its functionality, management controller 152 may perform all, or a portion, of the methods and operations illustrated in FIGS. 2-3.

While illustrated in FIG. 1B with a limited number of specific components, a system may include additional, fewer, and/or different components without departing from embodiments disclosed herein.

Turning to FIG. 1C, to provide computer-implemented services, hardware resources 150 may host processor 190, boot storage device 191, and storage device 192. For example, to place a data processing system (e.g., 100A) in a desired operating state, data processing system 100A may perform a startup process (e.g., a booting process) to initialize hardware resources and facilitate operation of an operating system. To do so, processor 190 may execute instructions indicated by startup data (e.g., firmware, system configuration, etc.) hosted by boot storage device 191.

Boot storage device 191 may include, for example, non-volatile flash memory (e.g., serial peripheral interface (SPI) flash) that may be hosted on a motherboard and adapted to store information, such as firmware, an image of a management entity (BIOS, unified extensible firmware interface (UEFI), etc.), system configuration files, and/or any other information usable to start up data processing system 100A. Because boot storage device 191 may have a limited storage capacity, storage device 192 may be used to store additional information (e.g., other copies of startup data).

Storage device 192 may include, for example, a second storage device such as a non-volatile memory express (NVMe) based solid-state drive. Storage device 192 may include a boot partition (193) that may be configured to store data usable to start up data processing system 100A (e.g., a desired of startup data, bootloader files, configuration files, etc.). Boot partition 193 may include an allocated section of storage device 192 that may, for example, be isolated from other memory sections of storage device 192. Furthermore, to provide its functionality, storage device 192 may include storage resources (e.g., flash memory cells), a controller (e.g., to manage operations of the storage device), an interface (e.g., to facilitate communication between the storage device and the processor), and/or any other components.

Storage device 192 may interact with processor 190 to store any number and/or types of data structures that may include for example, first information regarding occurrences of startup events identified by a startup management entity during a startup, second information regarding a predefined event identified by a management controller that may not be based on actions performed as part of the startup by the startup management entity, and/or any other information.

Processor 190 may include a central processing unit (CPU) that may interact with any number and/or type of other hardware components (e.g., boot storage device 191, storage device 192, and hardware components 195). For example, when data processing system 100A is powered on, processor 190 may be initialized to a predetermined state and directed to retrieve instructions (e.g., via a reset vector) from boot storage device 191. To interact with boot storage device 191, storage device 192, and/or the other hardware components, processor 190 may be operably connected to each of the components via in-band channels 171.

However, at least a portion of in-band channels 171 may not be functional and/or may have reduced functionality during booting of data processing system 100A and/or as a result of an undesired startup event that may prevent completion of the booting. For example, in an event that an operating system is not loaded as a result of the undesired startup event, software components that may depend on the operating system may not be operable, processor 190 may not be able to obtain information regarding hardware components 150, and/or any other conditions may prevent data processing system 100A from being placed in a desired operating state.

Thus, to improve a likelihood that data processing system 100A may be booted and placed in the desired operating state, management controller 152 may perform management functionalities using any number and/or type of side band channels (e.g. 174). For example, management controller may obtain information (e.g., telemetry data, sensor readings, etc.) regarding operation of hardware components of hardware resources 150 using a side band channel, communicate event data and/or requests to processor 190 via band channel 174A, provide notification of new event data to software components using a second side band channel, and/or perform any other actions by communicating with components of hardware resources regardless of an operating status of hardware resources 150.

To further clarify embodiments disclosed herein, an interaction diagram in accordance with an embodiment is shown in FIG. 2. The interaction diagram may illustrate how data may be obtained and used within the system of FIGS. 1A-1C.

In the interaction diagram, processes performed by and interactions between components of a system in accordance with an embodiment are shown. In the diagrams, components of the system are illustrated using a first set of shapes (e.g., 152, 200, etc.), located towards the top of each figure. Lines descend from these shapes. Processes performed by the components of the system are illustrated using a second set of shapes (e.g., 210, 212, etc.) superimposed over these lines. Interactions (e.g., communication, data transmissions, etc.) between the components of the system are illustrated using a third set of shapes (e.g., 214, 218, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the process labeled as 210 may occur prior to the interaction labeled as 212. However, it will be appreciated that the processes and interactions may be performed in different orders, any may be omitted, and other processes or interactions may be performed without departing from embodiments disclosed herein.

Turning to FIG. 2, an interaction diagram in accordance with an embodiment is shown. The interaction diagram may illustrate processes and interactions that may occur during management of a data processing system using event data regarding a predefined event relevant to operation of hardware resources of the data processing system.

To manage the data processing system based on the predefined event, event identification process 210 may be performed. Event identification process 210 may be performed, for example, prior to and/or concurrently with resumption process 214. During event identification process 210, an occurrence of a predefined event regarding operation of data processing system 100A may be identified by management controller 152, and event data regarding the predefined event may be obtained. For example, to identify the occurrence of the predefined event, management controller 152 may monitor a health status of hardware components, read data from sensors (e.g., temperature sensors, voltage sensors, accelerometer, etc.), compare the data to criteria (e.g., a threshold for a sensor data reading), infer that the predefined event has occurred based on the data, and/or via any other processes. The predefined event may include, for example, a change in an operational state of a hardware component (e.g., memory, disk, etc.), a change in operating conditions of a battery, a thermal event, a physical impact event (e.g., drop event), an electrical disturbance (e.g., power surge), and/or any other events that may impact desired operation of the data processing system.

At interaction 212, the event data may be provided to startup management entity 200 by management controller 152 while resumption process 214 is performed. For example, to provide the event data, management controller 152 may transmit at least a portion of the event data to startup management entity 200 via side band channel 174A, issue a request for startup management entity 200 to store the event data, communicate with startup management entity 200 utilizing an interface (e.g., advanced configuration and power interface (ACPI)) during the startup, and/or perform any other actions.

Startup management entity 200 may include, for example, software (e.g., BIOS, UEFI, etc.) stored on boot storage device 191 adapted to initialize operation of hardware resources of data processing system 100A. Startup management entity 200 may manage operation of processor 190 by executing instructions during a startup of data processing system 100A, performing startup processes to configure operation of the hardware resources, obtaining information regarding the startup processes, managing a transition of management responsibilities of processor 190 from startup management entity 200 to operating system 202, and/or performing any other actions.

To persistently store the event data, resumption process 214 may be performed. During resumption process 214, startup management entity 200 may perform actions to initialize and/or resume operation of hardware resources, store a data structure relevant to information obtained during the resumption in a persistent storage resource, and transition management of processor 190 to operating system 202. For example, to initialize operation of the hardware resources, startup management entity 200 may execute instructions indicated by startup data that may be hosted by a boot storage device, identify startup events (e.g., detecting presence of hardware components, locating drivers, etc.), perform validation of the hardware components based on the instructions, restore power to the hardware components (e.g., from a low-powered operating state), obtain first information relevant to the startup events (e.g., diagnostic results, runtime logs, etc.), and/or perform any other actions.

Startup management entity 200 may receive the event data, as previously discussed, from management controller 152 during the startup. For example, startup management entity 200 may receive a copy of the event data, issue a command to fetch the event data from management controller 152 based on a notification/request from management controller 152, and/or perform any other actions. Once obtained, startup management entity 200 may store the event data in a persistent storage resource. The persistent storage resource may include, for example, memory (e.g., non-volatile random access memory), storage resources of a storage device (e.g., a solid-state drive), and/or any other component. The event data may be stored in a data structure that may include, for example, first information (e.g., the BIOS log) based on startup events that occur during the startup, and second information related to the event data and/or the occurrence of the predefined event.

Furthermore, startup management entity 200 may process (e.g., compile into ACPI machine language) the data structure such that operating system 202 may interpret the data structure, implement security measures (e.g., sign the data structure using a trusted key (e.g., a private key of a public-private key pair), demonstrate authority to store the data structure in the persistent storage resource with a trusted platform module during the startup, and/or perform any other actions to persistently store the event data in the data structure so that the event data may be available to software services and operating system 202 after resumption process 214 is complete. As a result of performing resumption process 214, management of processor 190 may be transitioned from startup management entity 200 to operating system 202. Software components (e.g., software service 204) that operate cooperatively with operating system 202 may also become active as a result.

The lines descending from operating system 202 and software service 204 are shown in short dashing prior to completion of resumption process 214 to indicate that operating system 202 and software service 204 may not be active until resumption process 214 but become active following completion of resumption process 214 (e.g., lines descending shown in solid lines). Similarly, the line descending from startup management entity 200 is shown in short dashing following completion of resumption process 214 to indicate that startup management entity 200 may not be active following completion of resumption process 214.

To identify an action to perform based on the event data, data analysis process 216 may be performed. During data analysis process 216, the event data may be obtained from the persistent storage resource, and the event data may be evaluated to obtain an evaluation result. For example, to obtain the event data, software service 204 may: (i) automatically process the event data (e.g., based on a startup routine for software service 204, a trigger condition for when operating system 202 is active, a registration to receive updates regarding the predefined event, etc.), (ii) receive a notification from management controller 152 regarding an the occurrence of the predefined event, (iii) retrieve the data structure from the persistent storage resource based on the notification, and/or perform any other actions. Once obtained, software service 204 may evaluate the event data, for example, by comparing the event data to criteria indicated by an event policy, infer information about the predefined event based on the event data (e.g., a severity of the event, a type of the event, etc.), searching a repository using the information as a key to identify an action to perform, and/or perform any other actions to obtain a result regarding the occurrence of the predefined event. Software service 204 may process the event data, cooperatively and/or utilizing resources managed by operating system 202.

At interaction 218, the result may be provided to management system 102 by software service 204. For example, the result may be provided by transmitting a data package that may include a copy of at least a portion of the event data, the result, and/or any other information. To do so, software service 204 may include, for example, a remote telemetry service (e.g., a phone home service) adapted to communicate information to a remote management entity (e.g., management system 102) regarding operation of data processing system 100A. To communicate with management system 102, software service 204 may utilize a communication protocol (e.g., TCP/IP) to send and/or receive information.

To manage operation of data processing system 100A based on the event data, management process 220 may be performed. During management process 220, management system 102 may perform at least one management action to update operation of data processing system 100A. For example, based at least in part on the event data, management system 102 may proactively provide physical and/or virtual management services to data processing system 100A. For example, consider a scenario in which the event data indicates that a battery of data processing system 100A shows a decline in battery health that exceeds a threshold for expected decline in battery health. Management system 102 may notify a user of data processing system 100A, identify a level of serviceability of the battery (e.g., warranty status, ease of replacement, etc.), dispatch a support technician and/or a replacement battery, and/or perform any other actions to place data processing system 100A in a desired operating state.

Side band channel 174A may be used to facilitate communication between management controller 152 and processor 190, and is shown to indicate that management controller 152 may interface with processor 190 (e.g., while managed by startup management entity 200) regardless of a status of in-band channels (e.g., that may have reduced functionality due to an undesired startup event). Using the side band channels, management controller 152 may perform management commands that may include, for example, communicating information regarding the occurrence of a predefined event, transmitting data, issuing requests, and/or performing any other actions.

Thus, using processes and interactions shown in FIG. 2, a management controller of a data processing system may identify an occurrence of a predefined event (e.g., separate from startup events during a startup of the data processing system) and provide event data regarding the predefined event to a startup management entity during the startup. The event data may be stored by the startup management entity in a persistent storage resource for subsequent retrieval and processing by a software service. By doing so, the software service may identify an action to perform based on the event data to facilitate provisioning of desired computer-implemented services by the data processing system.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-1C may perform various methods to manage a data processing system. FIG. 3 illustrates a method that may be performed by the components of the system of FIGS. 1A-1C. In the diagrams discussed below and shown in FIG. 3, any of the operations may be repeated, performed in different orders, and/or performed in parallel with or in a partially overlapping in time manner with other operations.

Turning to FIG. 3, a flow diagram illustrating a method of managing operation of a data processing system in accordance with an embodiment is shown. The method may be performed, for example, by any of the components of the system of FIGS. 1A-1C, and/or other components not shown therein.

At operation 300, an occurrence of a predefined event may be identified by a management controller of the data processing system during a startup of the data processing system. The predefined event may include, for example, a change in an operational state of a hardware component (e.g., memory, disk, etc.), a change in operating conditions of a battery, a thermal event, a physical impact event (e.g., drop event), an electrical disturbance (e.g., power surge), and/or any other events that may impact desired operation of the data processing system. The occurrence of the predefined event may be identified by the management controller by: (i) monitoring operational states of the hardware components based on a schedule, (ii) collecting sensor readings prior to and/or during the startup, (iii) receiving telemetry data from the hardware components and/or sensors (e.g., based on an identification by the hardware components that the telemetry data exceeds a storage capacity of the hardware components), (iv) comparing information (e.g., the sensor readings) regarding the hardware components to event criteria (e.g., thresholds), (v) identifying an interrupt (e.g., a system interrupt) for the data processing system, and/or via any other processes.

At operation 302, event data regarding the predefined event may be provided by the management controller to a processor of the hardware resources while the processor is managed by a startup management entity. The event data may be provided to the startup management entity by: (i) adding the event data to a queue of data to be logged by the startup management entity during the startup, (ii) transmitting the event data to the startup management entity via a side band channel, (iii) providing a notification to the startup management entity to retrieve the event data from the management controller (e.g., using an event identifier), and/or via any other processes.

At operation 304, the event data may be stored in a persistent storage resource so that the event data is available to a software service after completion of the startup. The event data may be stored in the persistent storage resource by: (i) adding the event data to a data structure (e.g., a log, a file, etc.), (ii) compiling the data structure such that an operating system may interpret the data structure, (iii) signing the data structure using a trusted key (e.g., a private key of a public-private key pair), (iv) demonstrating authority with a trusted platform module to store the data structure in the persistent storage resource during the startup, and/or performing any other actions to persistently store the event data in the data structure so that the event data may be available to a software service and the operating system after the startup is complete.

At operation 306, the event data may be obtained from the persistent storage resource by the software service while the hardware resources are managed by an operating system. The event data may be obtained by: (i) automatically searching for the data structure in a predetermined storage location of the persistent storage resource upon initialization of the software service, (ii) retrieving the data structure based on a notification received from the operating system and/or the management controller, (iii) broadcasting a message indicating a request for new event data, and/or via any other processes.

At operation 308, at least one action may be performed using the event data to facilitate provisioning of computer-implemented services. The at least one action may be performed by: (i) evaluating the event data by comparing the event data to criteria indicated by an event policy, (ii) inferring information about the predefined event based on the event data (e.g., a severity of the event, a type of the event, etc.), (iii) communicating the information to a remote management entity for additional management services provided by the remote management entity, and/or performing any other actions.

The method may end following operation 308.

Using the method shown in FIG. 3, operation of a data processing system may be managed by persistently storing event data by a startup management entity so that the event data may be used by a software service after completion of a startup for the data processing system. By doing so, the software service may perform at least one action based on the event data to update operation of the data processing system.

Any of the components illustrated in FIGS. 1A-2 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing operation of a data processing system, the method comprising:
identifying, by a management controller of the data processing system, an occurrence of a predefined event during a resumption of the data processing system, the predefined event being relevant to operation of hardware resources of the data processing system;
based on the identifying:
providing, by the management controller via a side band channel, event data regarding the predefined event to a processor of the hardware resources, the processor being managed by a startup management entity during the resumption;
storing, by the startup management entity, the event data in a persistent storage resource so that the event data is available to a software service after completion of the resumption;
obtaining, by the software service, the event data from the persistent storage resource while the hardware resources are managed by an operating system; and
performing, by the software service, at least one action using the event data to facilitate provisioning of computer-implemented services.

2. The method of claim 1, wherein the persistent storage resource stores a data structure comprising:
first information regarding occurrences of startup events identified by the startup management entity during performance of the resumption; and
second information regarding the occurrence of the predefined event identified by the management controller, the occurrence of the predefined event occurring during the performance of the resumption, and the occurrence of the predefined event not being based on actions performed as part of the resumption and/or consequences of the actions being performed as part of the resumption.

3. The method of claim 2, wherein the predefined event comprises at least one event from a list of events consisting of:
a change in an operational state of a hardware component of the hardware resources;
a change in an operating condition of a battery of the hardware resources;
a thermal event;
a physical impact event; and
an electrical disturbance.

4. The method of claim 2, wherein storing the event data comprises:
adding the event data to the data structure hosted by the persistent storage resource.

5. The method of claim 2, wherein the software service is adapted to automatically process the data structure to identify at least the occurrence of the predefined event after the completion of the resumption.

6. The method of claim 5, wherein the software service performs the automatic processing after the completion of the resumption when a notification is received from the management controller.

7. The method of claim 6, wherein obtaining the event data comprises:
retrieving, by the software service, the event data from the persistent storage resource based on the notification.

8. The method of claim 1, wherein performing the at least one action comprises:
evaluating, by the software service, the event data based on an event policy to obtain an evaluation result; and
performing at least one management action based on the evaluation result.

9. The method of claim 8, wherein performing the at least one management action comprises:
providing, by the software service, the event data and/or the evaluation result to a remote entity tasked with managing operation of the data processing system.

10. The method of claim 1, wherein the management controller operates independently from and is distinct from the hardware resources.

11. The method of claim 10, wherein the management controller is on a separate power domain from the hardware resources so that the management controller is operable while the hardware resources are inoperable.

12. A non-transitory machine-readable medium having instructions stored therein, which when executed by a processor, cause the processor to perform operations for managing operation of a data processing system, the operations comprising:
identifying, by a management controller of the data processing system, an occurrence
of a predefined event during a resumption of the data processing system, the predefined event being relevant to operation of hardware resources of the data processing system;
based on the identifying:
providing, by the management controller via a side band channel, event data regarding the predefined event to a processor of the hardware resources, the processor being managed by a startup management entity during the resumption;
storing, by the startup management entity, the event data in a persistent storage resource so that the event data is available to a software service after completion of the resumption;
obtaining, by the software service, the event data from the persistent storage resource while the hardware resources are managed by an operating system; and
performing, by the software service, at least one action using the event data to facilitate provisioning of computer-implemented services.

13. The non-transitory machine-readable medium of claim 12, the persistent storage resource stores a data structure comprising:
first information regarding occurrences of startup events identified by the startup management entity during performance of the resumption; and
second information regarding the occurrence of the predefined event identified by the management controller, the occurrence of the predefined event occurring during the performance of the resumption, and the occurrence of the predefined event not being based on actions performed as part of the resumption and/or consequences of the actions being performed as part of the resumption.

14. The non-transitory machine-readable medium of claim 13, wherein the predefined event comprises at least one event from a list of events consisting of:
a change in an operational state of a hardware component of the hardware resources;
a change in an operating condition of a battery of the hardware resources;
a thermal event;
a physical impact event; and
an electrical disturbance.

15. The non-transitory machine-readable medium of claim 13, wherein storing the event data comprises:
adding the event data to the data structure hosted by the persistent storage resource.

16. The non-transitory machine-readable medium of claim 13, wherein the software service is adapted to automatically process the data structure to identify at least the occurrence of the predefined event after the completion of the resumption.

17. A system, comprising:
a processor; and
a memory coupled to the processor to store instructions, which when executed by the processor, cause the processor to perform operations for managing operation of a data processing system, the operations comprising:
identifying, by a management controller of the data processing system, an occurrence of a predefined event during a resumption of the data processing system, the predefined event being relevant to operation of hardware resources of the data processing system;
based on the identifying:
providing, by the management controller via a side band channel, event data regarding the predefined event to a processor of the hardware resources, the processor being managed by a startup management entity during the resumption;
storing, by the startup management entity, the event data in a persistent storage resource so that the event data is available to a software service after completion of the resumption;
obtaining, by the software service, the event data from the persistent storage resource while the hardware resources are managed by an operating system; and
performing, by the software service, at least one action using the event data to facilitate provisioning of computer-implemented services.

18. The system of claim 17, wherein the persistent storage resource stores a data structure comprising:
first information regarding occurrences of startup events identified by the startup management entity during performance of the resumption; and
second information regarding the occurrence of the predefined event identified by the
management controller, the occurrence of the predefined event occurring during the performance of the resumption, and the occurrence of the predefined event not being based on actions performed as part of the resumption and/or consequences of the actions being performed as part of the resumption.

19. The system of claim 18, wherein the predefined event comprises at least one event from a list of events consisting of:
a change in an operational state of a hardware component of the hardware resources;
a change in an operating condition of a battery of the hardware resources;
a thermal event;
a physical impact event; and
an electrical disturbance.

20. The system of claim 18, wherein storing the event data comprises:
adding the event data to the data structure hosted by the persistent storage resource.
